(19) United States
(12) Patent Application Publication
(10) Pub. No.: US 2026/0107220 A1
(43) Pub. Date: Apr. 16, 2026

(54) VEHICLE CONTROL DEVICE AND METHOD OF SELECTING NETWORK

(71) Applicants: HYUNDAI MOTOR COMPANY, SEOUL (KR); KIA CORPORATION, SEOUL (KR)

(72) Inventor: Sang Min Lee, Hwaseong-si (KR)

(73) Assignees: HYUNDAI MOTOR COMPANY, SEOUL (KR); KIA CORPORATION, SEOUL (KR)

(21) Appl. No.: 19/080,404

(22) Filed: Mar. 14, 2025

(30) Foreign Application Priority Data
Oct. 11, 2024 (KR) 10 2024 0138270

(51) Int. Cl. H04W 48/18; H04W 24/04; H04W 64/00; H04W 76/50

(52) U.S. Cl. CPC H04W 48/18; H04W 24/04; H04W 64/006; H04W 76/50

(57) ABSTRACT

A vehicle control device according to one embodiment of the present specification includes a control unit configured to generate a first network list in which communication service information is included, to set priorities in the first network list based on the communication service information, and to modify the priorities in the first network list based on a network connection result. A communication unit is also provided and is configured to connect to a network according to the set priorities, and a storage unit is configured to store a second network list to which the modified priorities are applied. When a communication mode is a callback mode, the control unit controls the communication unit to connect to the network according to the priorities in the second network list stored in the storage unit. Accordingly, it is possible to more quickly connect calls using the callback mode.

### CROSS REFERENCE TO RELATED APPLICATIONS

This application claims priority to and the benefit of Korean Patent Application No. 10-2024-0138270, filed on October 11, 2024, the disclosure of which is incorporated herein by reference in its entirety.

### BACKGROUND

### FIELD

The present specification relates to a vehicle control device and a method of selecting a network, and more specifically, to a vehicle control device that flexibly selects a network according to a communication environment and a method of selecting the network.

### DISCUSSION OF RELATED ART

As intelligent transportation systems (ITS) develop and the number of vehicles capable of wireless communication (e.g., WiFi, 3G, LTE, 5G, NR system, and the like) increases, communication between a vehicle and other vehicles or between the vehicle and external infrastructure is increasingly evolving into various service forms. In addition, the use of electronic control units (ECUs) in vehicles is increasing due to consumer needs and additional functions.

An emergency call (e-Call) system is a system that automatically or manually requests rescue from a rescue center even when an occupant of a vehicle loses consciousness or is unable to make a call when an accident of the vehicle occurs, thereby helping with rapid rescue. In recent years, the installation of e-Call systems in all types of passenger cars and light trucks has become mandatory, especially in the European Union (EU). A vehicle equipped with the e-Call system may communicate with a server through a modem installed in the vehicle to transmit accident information, including the location of the accident and the type of vehicle, to the rescue center. When the e-Call system is activated, the modem of the vehicle enters a callback mode in which calls are automatically received from a rescue center or the like for a set period of time.

Network search of a vehicle control device is performed in the order of fastest communication speed, for example, 4G-3G-2G. The callback mode is set to use 3G or 2G communication for stable call connection in emergency situations. In such situations, when a vehicle accident occurs in any one region of some country where the 3G network has been withdrawn and the callback mode is entered, the 3G band is searched for several tens of seconds and then a connection to the 2G band is attempted, and accordingly, it takes a long time to connect to the network. A method of flexibly selecting a network according to a local communication environment to enable faster voice communication in emergency situations is required.

### SUMMARY

The present specification is directed to providing a vehicle control device that adjusts priorities in a network list by reflecting a local communication environment and a network connection result to improve the related art, and a method of selecting a network.

The present specification is also directed to providing a vehicle control device that performs a network connection according to priorities in a network list in which a network connection result is reflected in a callback mode, and a method of selecting a network.

The present specification is also directed to providing a vehicle control device that performs a network connection according to priorities in a network list stored based on a communication environment of a region where a vehicle is located in a callback mode, and a method of selecting a network.

The present specification is also directed to providing a vehicle control device that considers a temporary network connection state when reflecting a network connection result in priorities in a network list, and a method of selecting a network.

The present specification is also directed to providing a vehicle control device in which priorities in a network list are determined to satisfy a communication speed condition preset in relation to an e-Call, and a method of selecting a network.

Problems to be solved by the present disclosure are not limited to those mentioned above, and other problems not mentioned will be clearly understood by those skilled in the art from the following description.

According to an aspect of the present specification, there is provided a vehicle control device including a control unit configured to generate a first network list in which communication service information is included, set priorities in the first network list based on the communication service information, and modify the priorities in the first network list based on a network connection result, a communication unit configured to connect to a network according to the set priorities, and a storage unit configured to store a second network list to which the modified priorities are applied, in which when a communication mode is a callback mode, the control unit controls the communication unit to connect to the network according to the priorities in the second network list stored in the storage unit.

According to another aspect of the present specification, there is provided a method of selecting a network, including generating a first network list in which communication service information is included, setting priorities in the first network list based on the communication service information, connecting to a network according to the set priorities, modifying the priorities in the first network list based on a connection result, and storing a second network list to which the modified priorities are applied, in which when a communication mode is a callback mode, connecting to the network according to the priorities in the second network list is performed.

Details of other embodiments are included in the detailed description and drawings.

According to embodiments of the present specification, in a callback mode, a network connection can be performed using a network list stored in advance to have priorities in which a local communication environment and a network connection result are reflected, thereby allowing a call connection to be more quickly made in an emergency situation such as a vehicle accident using the callback mode.

According to embodiments of the present specification, in a situation where, when a network switching event occurs, a specific network is temporarily unavailable for connection, such as a network failure, entrance into a basement of a building, or the like, by applying priority changes differently from general network connection failure cases when setting priorities, priority setting of a network list can be more accurately made.

According to embodiments of the present specification, a network connection may be determined to satisfy a preset communication speed condition in relation to an e-Call among priorities in a stored network list, thereby allowing the network connection to be more quickly established without delay due to unnecessary search.

Effects of the present disclosure are not limited to those mentioned above, and other effects not mentioned will be clearly understood by those skilled in the art from the description below.

### BRIEF DESCRIPTION OF THE FIGURES

The above and other objects, features and advantages of the present disclosure will become more apparent to those of ordinary skill in the art by describing exemplary embodiments thereof in detail with reference to the accompanying drawings, in which:

FIG. 1 is a block diagram illustrating an e-Call system of a vehicle according to one embodiment of the present specification;

FIG. 2 is a diagram illustrating a vehicle communication control device according to one embodiment of the present specification;

FIG. 3 is a flowchart illustrating a method of selecting a network according to one embodiment of the present specification;

FIG. 4 is a flowchart illustrating a method of reflecting a network connection result in priorities in a network list according to one embodiment of the present specification; and

FIG. 5 is a flowchart illustrating a method of setting the priorities in the network list according to one embodiment of the present specification.

### DETAILED DESCRIPTION

Advantages and features of the present disclosure, and methods of achieving the advantages and features will be clarified with reference to embodiments described below in detail together with the accompanying drawings. However, the present disclosure is not limited to the embodiments disclosed below, but will be implemented in a variety of different forms. The present embodiments are only provided to allow disclosure of the present disclosure to be completed, and to completely inform those skilled in the art to which the present disclosure belongs of the scope of the disclosure, and the present disclosure is merely defined by scope of the claims.

The shapes, sizes, ratios, angles, numbers, etc., disclosed in the drawings for describing embodiments of the present disclosure are illustrative, and the present disclosure is not limited to the matters illustrated. Like reference numerals refer to like elements throughout the specification. Furthermore, in describing the present disclosure, when it is determined that the detailed description of the related known technology may obscure the subject matter of the present disclosure, the detailed description thereof will be omitted. When “include,” “have,” “comprise,” etc., mentioned in the present specification are used, other parts may be added unless “only” is used. In describing a component in the singular, cases where the component is plural are included unless expressly stated otherwise.

In interpreting a component, the component is interpreted as including an error range even with no explicit description.

In describing a position relationship, for example, when a position relation between two parts is described as “on,” “over,” “under,” or “next to,” one or more other parts may be disposed between the two parts unless “just” or “directly” is used.

In describing a time relationship, for example, when the temporal order is described as “after,” “subsequent to,” “next to,” or “before,” a case where the time relationship is not a continuous one may be included unless “just” or “immediately” is used.

“Unit” used throughout the present specification is a unit that processes at least one function or operation, and may refer to software or hardware components. Functions provided by “~unit” may be separately performed by a plurality of components, or may be integrated with other additional components. The “~unit” of the present specification may be implemented through a single circuit or a plurality of circuits, or through a single device or a plurality of devices.

Features of various embodiments of the present disclosure may be partially or fully coupled or combined with each other and may be variously inter-operated and driven technically, and embodiments may be carried out independently of each other or may be carried out together in a related manner.

Hereinafter, a vehicle control device and a method of selecting a network according to an embodiment of the present specification will be described with reference to the attached drawings.

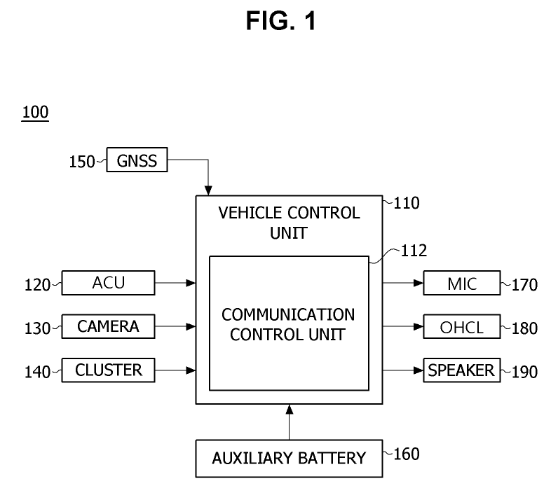

FIG. 1 is a block diagram illustrating an e-Call system of a vehicle according to an embodiment of the present specification.

Referring to FIG. 1, an emergency call (e-Call) system 100 of a vehicle according to an embodiment of the present specification may include a vehicle control unit 110 including a communication control unit 112, an airbag control unit (ACU) 120, a camera 130, a cluster 140, a satellite positioning system module (global navigation satellite system (GNSS)) 150, an auxiliary battery 160, a microphone (MIC) 170, an overhead console lamp (OHCL) 180, and a speaker 190.

The vehicle control unit 110 or a vehicle control device 110 may recognize the occurrence of an accident based on signals from the airbag control unit 120, the camera 130, or the cluster 140, collect vehicle information at the time of the accident, generate a minimum set of data (MSD) message, and then transmit the message to a rescue center called a public safety answering point (PSAP) through the communication control unit 112. The communication control unit 112 may be a device implemented to enable wireless communication (e.g., 3G, 4G, and the like).

The satellite positioning system module 150 is for obtaining location information about a vehicle and provides the obtained location information to the vehicle control unit 110. The location information about the vehicle may be obtained in various methods using the satellite positioning system module 150 and the present embodiment is not limited to a specific method.

The e-Call-system 100 operates based on power provided from a main battery. When the vehicle control unit 110 determines that power is not normally supplied from the main battery due to a vehicle accident, a power supply path may be switched from the main battery to the auxiliary battery 160, and the e-Call system 100 may operate by receiving power from the auxiliary battery 160. For example, the vehicle control unit 110 may determine that power from the main battery is not normally supplied when power from the main battery is not supplied or when the power supplied from the main battery is equal to or lower than a preset reference value.

The vehicle control unit 110 may transmit vehicle information at the time of an accident to the rescue center, and may also transmit accident information to a head unit (HU) of the vehicle through controller area network (CAN) communication and display the accident information. Regarding an emergency rescue request, functions of the in-vehicle microphone 170 and the speaker 190 may be automatically activated for a call to the rescue center, the overhead console lamp 180 may light up, and an emergency rescue request button may be activated. The function of the microphone 170 may also be performed through the head unit through switching when a vehicle accident occurs.

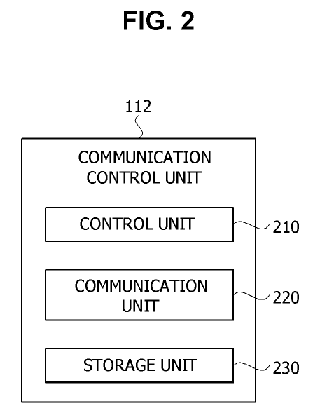

FIG. 2 is a diagram illustrating a vehicle communication control device according to one embodiment of the present specification.

Referring to FIG. 2, a communication control unit 112 or a vehicle communication control device 112 according to the embodiment of the present specification may include a control unit 210, a communication unit 220, and a storage unit 230.

The control unit 210 searches for a network and performs a function of connecting the network between the vehicle and an external server through the communication unit 220. The control unit may generate a network list in which communication service information is included, set priorities in the network list, and modify the priorities in the network list based on a network connection result. In one embodiment, the control unit 210 may be a processor made up of hardware components that perform arithmetic, logic, and input/output operations and image processing.

The communication unit 220 performs a function of connecting the external server and the network and transmitting and receiving data to and from the external server under the control of the control unit 210. The communication unit 220 may connect networks to external servers in order according to the set priorities in the network list. In one embodiment, the communication unit 220 may be a vehicle modem. In addition, the communication unit 220 may be a communication module or communication interface that establishes a wireless communication channel and supports communication performance through the established communication channel.

The storage unit 230 performs a function of storing commands or data during a vehicle communication control process. The network list to which the priorities modified by the control unit 210 are applied may be stored in the storage unit 230. When a communication mode is a callback mode, the control unit 210 may control the communication unit 220 according to the priorities in the network list stored in the storage unit 230 to connect the network to the external server. In one embodiment, the storage unit 230 may be a memory in which instructions, algorithms, program codes, and the like that may be read by the processor are stored.

In addition, the network list according to one embodiment of the present specification may be a public land mobile network (PLMN) list, and based on the list, communication may be performed according to various wireless communication standards such as 3rd Generation (3G), 3rd Generation Partnership Project (3GPP), Long Term Evolution (LTE), LTE Advanced (LTE-A), 4th Generation (4G), 5th Generation (5G), and the like. In the present specification, the terms “4G” and “3G” may be used to mean not only the generation of communication technology but also the difference in communication speed.

A network connection process of a general vehicle communication may be as follows. A connection to a network is attempted based on the network list. When the network connection fails, the highest priority is selected among the available network service providers and networks are sequentially searched for in the order of fastest communication speed, for example, 4G-3G-2G, to connect the network.

Meanwhile, the e-Call is required by law to maintain the callback mode for reconnecting the call after an emergency rescue call for a certain period of time. When the communication mode is the callback mode of the e-Call, in order to ensure a stable call connection, the network connection may be set to use a network having a relatively low communication speed, such as a 3G or 2G communication network. In the situation described above, when an accident of a vehicle occurs in a country where some 3G communication networks have been withdrawn and the e-Call system is activated and the communication mode enters the callback mode, the band for the 3G communication network is searched for a certain period of time and then a connection to the 2G communication network is attempted, and thus a delay in the network connection occurs. In a situation where a call connection is urgently needed, the network connection delay may be fatal.

Hereinafter, a method of selecting a network that allows for faster and more stable network connection in a callback mode will be described.

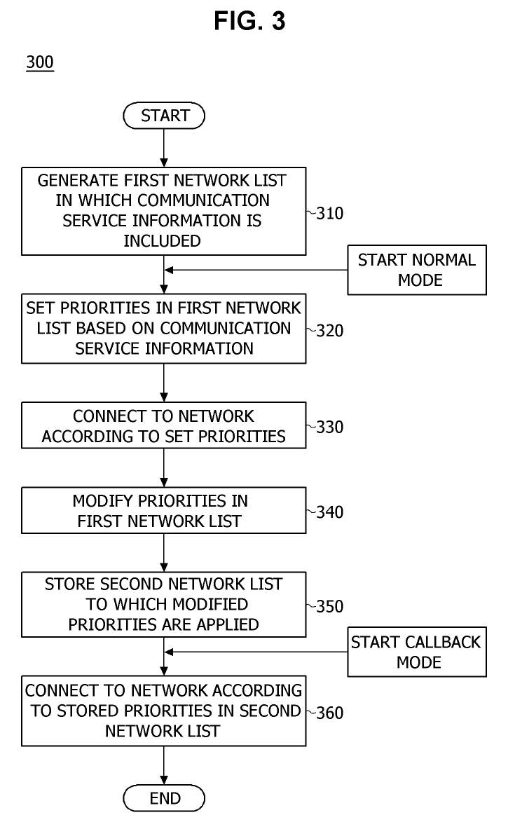

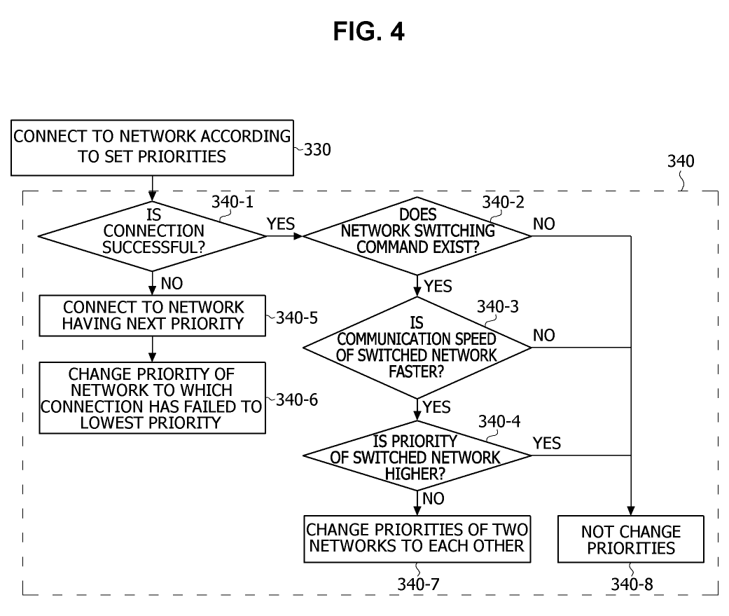

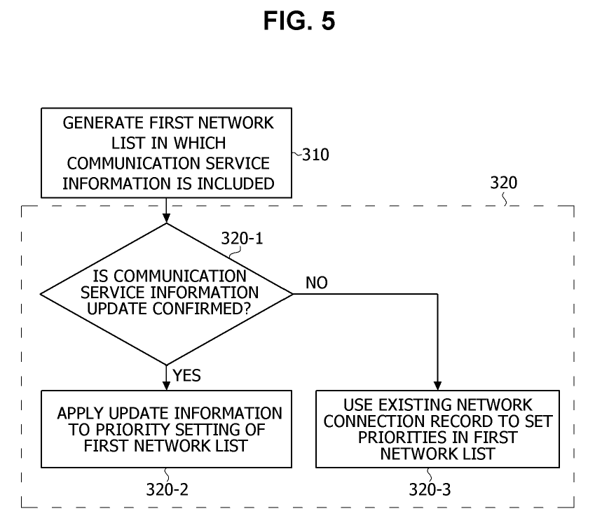

FIG. 3 is a flowchart illustrating a method of selecting a network according to one embodiment of the present specification, FIG. 4 is a flowchart illustrating a method of reflecting a network connection result in priorities in a network list, and FIG. 5 is a flowchart illustrating a method of setting the priorities in the network list.

Referring to FIG. 3, the method of selecting a network according to one embodiment of the present specification may be performed as follows.

In operation 310, the vehicle control device 110 may generate a first network list in which communication service information is included. The communication service information may include regional information, communication service provider information, and communication speed information. In one embodiment, the communication service information may include country-specific communication service provider information and information on communication specifications for each communication service.

In operation 320, the vehicle control device 110 may set priorities in the first network list based on the communication service information. Referring to FIG. 5 together, in operation 320-1, it is confirmed whether the communication service information has been updated, and when it is confirmed that the update has been performed since the last use of network communication, the method proceeds to operation 320-2, and setting of the priorities in the first network list may be performed based on the updated communication service information. In operation 320-1, when it is not confirmed that the update has been performed, the method proceeds to operation 320-3, and the setting of priorities in the first network list may be performed based on an existing network connection record, specifically, a network connection record for the last used network communication.

Regarding the priority setting, a region where a vehicle is located may be checked and matched with the regional information included in the communication service information, and the priorities may be determined based on the communication service provider information and communication speed information associated with the checked region. In one embodiment, the vehicle control device 110 may check a country in which a vehicle is currently located and then check a contracted communication service provider in that country. In addition, the vehicle control device 110 may select a communication service provider and set priorities so that networks are searched for in the order of fastest communication speed, for example, 4G-3G-2G.

In operation 330, the vehicle control device 110 may perform connection to a network according to the set priorities in the first network list.

In operation 340, the vehicle control device 110 may modify the priorities in the first network list based on a connection result in operation 330. Referring to FIG. 4, in operation 340-1, when the network connection fails, the method proceeds to operations 340-5 and 340-6 to perform to connect to a network having a next priority after a network to which the connection has failed, and the priority of the network to which the connection has failed may be changed to a lowest priority.

Some of cases where the network connection fails include cases where a network is temporarily unavailable for connection, such as a temporary network failure or entrance into an underground parking lot of a building or a tunnel, and even in the special cases, the priority of the network to which the connection has failed may be changed to the lowest priority. Therefore, the priority setting of the network list is required to be more accurately performed by applying the priority change differently from a case of general network connection failure when the priorities are set.

When the network connection is successful in operation 340-1, the method proceeds to operation 340-2 to check whether a network switching command is received from a base station while using the network, and when there is no network switching command, the method proceeds to operation 340-8 so that the priorities in the first network list may be maintained as they are without change.

When there is the network switching command in operation 340-2 again, the method proceeds to operation 340-3 to compare communication speeds of the network in use (first network) and a network (second network) to be connected through a change by the network switching command, and when the communication speed of the network to be connected through the change by the network switching command is faster than the network in use, that is, when the second network has a faster communication speed than the first network, the method proceeds to operation 340-4. In operation 340-4, it is determined whether the switched network has a higher priority than the network in use, that is, whether the second network has a higher priority than the first network, and when the second network has a higher priority than the first network, the method proceeds to operation 340-8, and the priorities in the first network list may be maintained as they are without change. When the network in use has a higher priority than the switched network, that is, the first network has a higher priority than the second network, the method proceeds to operation 340-7 to change the priority of the first network and the priority of the second network to each other in the first network list.

When the communication speed of the network to be connected through the change by the network switching command in operation 340-3 is not faster than that of the network in use, that is, when the first network that is the the network in use is switched to a third network having a relatively slow communication speed so that the third network is connected, the priorities in the first network list may be maintained as they are without change by proceeding to operation 340-8.

In operation 350, the vehicle control device 110 may store a second network to which the modified priorities are applied.

In the second network list stored through the process described above, the priorities may be set based on the communication service provider information associated with a region (e.g., a country) where a vehicle accident may occur and communication speed in preparation for the operation of the e-Call system, and the priorities may be modified by reflecting the actual network connection result, so that in emergency situations, a network connection may be quickly and reliably performed using the modified priorities.

In operation 360, the vehicle control device 110 may connect to the network according to the priorities in the second network list when the communication mode is the callback mode.

In one embodiment, the callback mode is a communication mode according to an e-Call operation related to an emergency rescue request when an accident of a vehicle occurs, and the vehicle control device 110 may perform a network connection to satisfy a preset communication speed condition for a stable call connection in the callback mode.

Referring to FIG. 3 again, unlike when a network connection is generally made for vehicle communication, the vehicle control device 110 may cause the method to proceed directly to operation 360 when entering the callback mode by the operation of the e-Call system so that the preset communication speed condition is applied according to the priorities in the second network list stored in advance, thereby more quickly and stably performing the network connection, and accordingly, preventing an unnecessary call connection delay in an emergency situation.

As described so far, a vehicle control device according to one embodiment of the present specification and a method of selecting a network may perform a network connection using a network list stored in advance to have priorities in which a local communication environment and a network connection result are reflected in a callback mode, thereby allowing a call connection to be more quickly made in an emergency situation such as a vehicle accident using the callback mode. In addition, by taking into account a situation where a specific network is temporarily unavailable for connection, priorities may be more accurately set, and the network connection may be determined to satisfy a preset communication speed condition related to the e-call, thereby preventing the delay due to an unnecessary search.

The embodiments of the present disclosure have been described in more detail with reference to the accompanying drawings, but the present disclosure is not necessarily limited to the embodiments, and may be implemented in various modifications without departing from the spirit of the present disclosure. Accordingly, the embodiments disclosed in the present disclosure are not intended to limit the scope of the present disclosure, but to explain the scope, and the scope of the spirit of the present disclosure is not limited by the embodiments. Therefore, it should be appreciated that the embodiments described above are intended to be illustrative in all respects and not restrictive. The scope of the present disclosure should be interpreted based on the accompanying claims, and all technical concepts within the scope equivalent to the claims should be construed as being included in the scope of the present disclosure.

1. A vehicle control device comprising:
a control unit configured to generate a first network list in which communication service information is included, set priorities in the first network list based on the communication service information, and modify the priorities in the first network list based on a network connection result;
a communication unit configured to connect to a network according to the set priorities; and
a storage unit configured to store a second network list to which the modified priorities are applied,
wherein, when a communication mode is a callback mode, the control unit controls the communication unit to connect to the network according to the priorities in the second network list stored in the storage unit.

2. The vehicle control device of claim 1, wherein the communication service information includes regional information, communication service provider information, and communication speed information.

3. The vehicle control device of claim 2, wherein the setting of the priorities in the first network list is performed to check a region where a vehicle is located to match the region with the regional information, and to determine the priorities based on the communication service provider information and the communication speed information associated with the checked region.

4. The vehicle control device of claim 1, wherein the modifying of the priorities in the first network list is performed by connecting to a network having a next highest priority after a network to which connection has failed, and changing a priority of the network to which the connection has failed to a lowest priority.

5. The vehicle control device of claim 1, wherein the modifying of the priorities in the first network list is performed when a network switching command for a network in use is received.

6. The vehicle control device of claim 5, wherein a first network that is the network in use is changed to a second network having a faster communication speed than the first network by the network switching command so that the second network is connected,
when a priority of the first network is higher than a priority of the second network, the priorities of the first network and the second network in the first network list are switched, such that the priority of the first network is assigned as the priority of the second network and the priority of the second network is assigned as the priority of the first network, and,
when the priority of the first network is lower than the priority of the second network, the priorities in the first network list are maintained.

7. The vehicle control device of claim 5, wherein a first network that is the network in use is changed to a third network having a slower communication speed than the first network by the network switching command so that the third network is connected, and
the priorities in the first network list are maintained as they are.

8. The vehicle control device of claim 1, wherein the setting of the priorities in the first network list is performed based on updated communication service information when an update of the communication service information is confirmed.

9. The vehicle control device of claim 8, wherein the setting of the priorities in the first network list is performed based on an existing network connection record of the first network list when the update of the communication service information is not confirmed.

10. The vehicle control device of claim 3, wherein the callback mode is a communication mode according to an e-Call operation related to an emergency rescue request when an accident of the vehicle occurs, and is a communication mode in which a network connection is performed to satisfy a preset communication speed condition,
a region in which the accident of the vehicle occurs is the checked region, and,
when the communication mode is the callback mode, the control unit controls the communication unit to connect to the network in an order in which the communication speed condition is satisfied among the priorities in the second network list stored in the storage unit.

11. A method of selecting a network, comprising:
generating a first network list in which communication service information is included;
setting priorities in the first network list based on the communication service information;
connecting to a network according to the set priorities;
modifying the priorities in the first network list based on a connection result; and
storing a second network list to which the modified priorities are applied,
wherein when a communication mode is a callback mode, connecting to the network according to the priorities in the second network list is performed.

12. The method of claim 11, wherein the communication service information includes regional information, communication service provider information, and communication speed information.

13. The method of claim 12, wherein the setting of the priorities in the first network list includes:
checking a region where a vehicle is located to match the region with the regional information; and
determining the priorities based on the communication service provider information and the communication speed information associated with the checked region.

14. The method of claim 11, wherein the modifying of the priorities in the first network list includes:
connecting to a network having a next highest priority after a network to which connection has failed; and
changing a priority of the network to which the connection has failed to a lowest priority.

15. The method of claim 11, wherein the modifying of the priorities in the first network list is performed when a network switching command for a network in use is received.

16. The method of claim 15, wherein a first network that is the network in use is changed to a second network having a faster communication speed than the first network by the network switching command so that the second network is connected,
when a priority of the first network is higher than a priority of the second network, the priorities of the first network and the second network in the first network list are changed to each other, and
when the priority of the first network is lower than the priority of the second network, the priorities in the first network list are maintained as they are.

17. The method of claim 15, wherein a first network that is the network in use is changed to a third network having a slower communication speed than the first network by the network switching command so that the third network is connected, and
the priorities in the first network list are maintained as they are.

18. The method of claim 11, wherein the setting of the priorities in the first network list is performed based on updated communication service information when an update of the communication service information is confirmed.

19. The method of claim 18, wherein the setting of the priorities in the first network list is performed based on an existing network connection record of the first network list when the update of the communication service information is not confirmed.

20. The method of claim 13, wherein the callback mode is a communication mode according to an e-Call operation related to an emergency rescue request when an accident of the vehicle occurs, and is a mode in which a network connection is performed to satisfy a preset communication speed condition,
a region in which the accident of the vehicle occurs is the checked region, and,
when the communication mode is the callback mode, the connection to the network is performed in an order in which the communication speed condition is satisfied among the priorities in the second network list.
